(19) United States
(12) Patent Application Publication
(10) Pub. No.: US 2015/0037584 A1
(43) Pub. Date: Feb. 5, 2015

(54) GRINDING OF AN ALKALI OR ALKALINE EARTH METAL BOROHYDRIDE

(71) Applicant: Rohm and Haas Company, Philadelphia, PA (US)

(72) Inventors: Michael Bender, Willow Grove, PA (US); Samuel November, Newtown, PA (US); John Reffner, North Wales, PA (US); John Yamamoto, Doylestown, PA (US)

(21) Appl. No.: 14/374,542

(22) PCT Filed: Feb. 1, 2013
(86) PCT No.: PCT/US13/24249

§ 371 Date: Jul. 25, 2014

Related U.S. Application Data
(60) Provisional application No. 61/594,468, filed on Feb. 3, 2012.

(51) Int. Cl. C01B 6/21; B02C 19/06; B02C 23/06

(52) U.S. Cl. CPC C01B 6/21; B02C 23/06; B02C 19/06
USPC 428/402; 241/22; 241/5

(57) ABSTRACT

A method for grinding a solid composition comprising an alkali or alkaline earth metal borohydride to produce a solid composition having a stable average particle size by grinding the alkali or alkaline earth metal borohydride in the presence of fumed silica, magnesium carbonate, or a combination thereof.

This invention relates to a method for grinding an alkali or alkaline earth metal borohydride and solid alkali or alkaline earth metal borohydride-containing formulations.

Sodium borohydride and sodium borohydride-containing compositions are known to be difficult to grind to produce extremely small particles. For example, R. A. Varin & Ch. Chiu, J. Alloys Compd., vol. 397, 276-281 (2005) discloses ball milling of sodium borohydride. However, size reduction of sodium borohydride was not achieved in this reference. The only changes observed after many hours of milling were changes in surface structure of the sodium borohydride.

The problem addressed by this invention is to find a method for grinding an alkali or alkaline earth metal borohydride and solid alkali or alkaline earth metal borohydride-containing formulations.

### STATEMENT OF INVENTION

The present invention provides a method for grinding a solid composition comprising an alkali or alkaline earth metal borohydride to produce a solid composition having a stable median particle size. The method comprises grinding the solid composition comprising an alkali or alkaline earth metal borohydride in the presence of fumed silica, magnesium carbonate, or a combination thereof.

The present invention is further directed to a composition comprising an alkali or alkaline earth metal borohydride and at least one of fumed silica and magnesium carbonate; wherein median particle size of the composition is less than 30 microns.

### DETAILED DESCRIPTION

Percentages are weight percentages (“wt %”) and temperatures are in ° C., unless specified otherwise. “Room temperature” is the ambient indoor temperature, typically 20-25° C. Median particle size is determined using a MALVERN MASTERSIZER 2000 with a 2000 μP Module. Samples are manipulated in dry nitrogen atmospheres and mixed with a solvent, e.g., p-xylene, containing a nonionic surfactant, e.g., NINATE 60L at ca. 0.15 wt %, with an alkali metal borohydride concentration of ca. 1 wt %, and sonicated for four minutes. “Fumed silica” is silica produced by pyrolysis of silicon compounds at high temperatures. Typical specifications are as follows: average particle size is 5-50 nm; surface area is 50-600 m²/g; density 160-190 kg/m³. Preferably, average particle size is 10-40 nm; surface area is 75-500 m²/g. Preferably, magnesium carbonate used in the method of this invention has a water content no more than 1 wt %, preferably no more than 0.5 wt %, preferably no more than 0.2 wt %, preferably no more than 0.1 wt %. Preferably, magnesium carbonate has an average particle size prior to grinding from 1 micron to 50 microns, preferably from 10 microns to 40 microns.

Preferably, fumed silica, magnesium carbonate, or a combination thereof is added to the alkali or alkaline earth metal borohydride in a total amount from 0.5 wt % to 7 wt %, based on total weight of the composition; preferably at least 0.7 wt %, preferably at least 0.8 wt %, preferably at least 0.9 wt %, preferably at least 1 wt %; preferably no more than 6 wt %, preferably no more than 5.5 wt %, preferably no more than 5 wt %, preferably no more than 4.5 wt %, preferably no more than 4 wt %, preferably no more than 3.5 wt %. Preferably, the solid composition comprising an alkali or alkaline earth metal borohydride is ground to a median particle size of less than 25 microns, preferably less than 20 microns, preferably less than 15 microns, preferably less than 12 microns. Preferably the solid composition is ground to a median particle size no less than 2 microns, preferably no less than 3 microns, preferably no less than 4 microns.

Preferably, the alkali or alkaline earth metal borohydride is an alkali metal borohydride or calcium borohydride; preferably sodium borohydride, potassium borohydride, calcium borohydride or lithium borohydride; preferably sodium borohydride, potassium borohydride or lithium borohydride; preferably sodium borohydride or potassium borohydride; preferably sodium borohydride. Preferably, the alkali or alkaline earth metal borohydride has an average particle size prior to grinding from 50 microns to 1000 microns, preferably from 100 microns to 300 microns. Preferably, the alkali or alkaline earth metal borohydride prior to grinding has no more than 1 wt % water, preferably no more than 0.5 wt %, preferably no more than 0.2 wt %, preferably no more than 0.1 wt %.

Preferably, the water content of the ground solid composition is no more than 0.5%, preferably no more than 0.2%, preferably no more than 0.1%. Preferably, the ground solid composition contains less than 5% of anything other than the alkali or alkaline earth metal borohydride, silica and magnesium carbonate, preferably less than 3%, preferably less than 2%, preferably less than 1%, preferably less than 0.5%. Other possible constituents of the ground solid composition include, e.g., anti-foam agents and surfactants, preferably anionic surfactants, preferably surfactants having sulfonate or carboxylate groups. The ground solid composition may be dispersed in a non-reactive organic solvent, preferably a hydrocarbon solvent.

Preferably, the solid composition comprising an alkali or alkaline earth metal borohydride is ground in a mill capable of producing particles having a median particle size less than 50 microns, e.g., fluid energy mills (fluidized jet mill, spiral jet mill), ball mills (vibration, centrifugal, gravity), wet media mills (stirred media mill). Preferably, the parts of the mill which contact the solid composition are made of stainless steel. Preferably, milling is done at a temperature from 0° C. to 100° C., preferably from 10° C. to 40° C. Preferably, the mill is cooled by a cooling jacket to maintain temperature in the aforementioned ranges. Preferably, the milling time in a ball mill is from 1 minute to 2 hours; preferably at least 2 minutes, preferably at least 5 minutes, preferably at least 10 minutes; and preferably the milling time is no more than 1.5 hours, preferably no more than 1 hour, preferably no more than 50 minutes, preferably no more than 40 minutes. The number and size of the balls and the rotation rate can easily be determined by those of skill in the art depending on the target particle size. Preferably, grinding in jet mills is controlled by pressure. In a spiral jet mill the pressure preferably is at least 30 psig (300 kPa), preferably at least 50 psig (440 kPa), preferably no more than 250 psig (1800 kPa). In a fluidized bed jet mill, preferably the pressure is from 2-18 atmospheres (200-1800 kPa), preferably from 4-15 atmospheres (400-1500 kPa). Feed rates and the number of passes through the jet mills can easily be determined by those of skill in the art depending on the target particle size.

### EXAMPLES

All manipulations were done in an inert atmosphere, using standard laboratory procedures. Fumed silica, magnesium carbonate and VENPURE™ SF sodium borohydride powder containing 200 ppm silica were obtained from the Dow Chemical Company. Their characteristics were as follows.

| | D [4, 3]- | D [3, 2]- | | | | |
|---|---|---|---|---|---|---|
| | Volume | Surface | | | | |
| | weighted | weighted | d | d | d | % less |
| Sample Name | mean | mean | (0.1) | (0.5) | (0.9) | than 5 μm |
| VENPURE SF | 235 | 145 | 86 | 209 | 429 | 0 |
| powder | | | | | | |
| CARBOSIL, | 164 | 25 | 13 | 27 | 41 | 0.0 |
| pure | | | | | | |
| MgCO₃ | 20.3 | 18.2 | 12.5 | 19.3 | 29.3 | 0.0 |

All mixtures of sodium borohydride and silica and/or magnesium carbonate additive(s) were made by weighing out the appropriate amounts of ingratiates into 250 mL NALGENE™ bottles. The mixtures were shaken by hand for 1 min. The samples were sieved through a 425 mesh filter before use. The material needed to be sieved to remove any clumps that might have plugged the solid feed nozzle of the jet mill.

The material was milled in a jet mill. The material was packed into 250 mL NALGENE™ bottles and stored on a shelf at room temperature. Particle size analysis of milled material after 30 days of storage showed that particle size of the milled materials did not change as much when the additives were present. The material that did not have an additional amount of the additives did reagglomerate more than the other material as measured by the 9-month data.

| | | Median | | Ratio | |
|---|---|---|---|---|---|
| | | Particle | | Start to | Propa- |
| | | Size, | Est std | Nine | gated |
| Additive | Time | d(0.5) | dev | Months | Error |
| 2% SiO₂ | Start | 9.1 | 0.18 | | |
| 2% SiO₂ | 9 months | 9.3 | 0.19 | 1.03 | 0.03 |
| 1% MgCO₃ | Start | 5.5 | 0.11 | | |
| 1% MgCO₃ | 9 months | 6.7 | 0.13 | 1.22 | 0.03 |
| 5% MgCO₃ | Start | 4.7 | 0.09 | | |
| 5% MgCO₃ | 9 months | 6.2 | 0.12 | 1.31 | 0.04 |
| NaBH₄ ground powder | Start | 5.9 | 0.12 | | |
| NaBH₄ ground powder | 9 months | 8.9 | 0.18 | 1.52 | 0.04 |

Note:
Used pooled % RSD to calc approx 95% confidence level

“Est std dev” is the estimated standard deviation of each observed diameter, based on the average percent relative standard deviation calculated for all samples in the total pool of this study. The units are diameter in microns.
“Propagated Error” is the 95% confidence level for the ratio of nine month diameter to starting diameter. It was calculated using (a) the estimated standard deviations for each sample, (b) the assumption of random error constituting the total error in the analysis, and (c) the standard calculus result for propagating the total uncertainty of all random errors in a numerator and denominator when calculating the random error in the result ratio of those values (see, e.g., pp. 46-50 in Experiments in Physical Chemistry, 4th Edition, D. P. Shoemaker, C. W. Garland, J. I Steinfeld and J. W. Nibler, McGraw-Hill Inc, 1981.

1. A method for grinding a solid composition comprising an alkali or alkaline earth metal borohydride to produce a ground solid composition having a stable median particle size; said method comprising grinding the solid composition comprising an alkali or alkaline earth metal borohydride in the presence of fumed silica, magnesium carbonate, or a combination thereof.

2. The method of claim 1 in which the ground solid composition contains fumed silica, magnesium carbonate, or a combination thereof in a total amount from 0.5 wt % to 7 wt %, based on total weight of the ground solid composition.

3. The method of claim 2 in which a median particle size for the ground solid composition is less than 30 microns.

4. The method of claim 3 in which the alkali or alkaline earth metal borohydride is sodium borohydride.

5. The method of claim 4 in which median particle size of the ground solid composition is from 2 microns to 25 microns.

6. The method of claim 5 in which the solid composition comprising an alkali or alkaline earth metal borohydride is ground in a fluidized jet mill or pancake jet mill.

7. A composition comprising an alkali or alkaline earth metal borohydride and at least one of fumed silica and magnesium carbonate; wherein median particle size of the composition is less than 30 microns.

8. The composition of claim 7 in which the solid composition contains fumed silica, magnesium carbonate, or a combination thereof in a total amount from 0.5 wt % to 7 wt %, based on total weight of the composition.

9. The composition of claim 8 in which the alkali or alkaline earth metal borohydride is sodium borohydride.

10. The composition of claim 9 in which median particle size of the composition is from 2 microns to 25 microns.
